(19) United States
(12) Patent Application Publication
(10) Pub. No.: US 2010/0010734 A1
(43) Pub. Date: Jan. 14, 2010

(54) NAVIGATION DEVICE AND METHOD FOR CALCULATING AN ESTIMATED TOTAL TIME REQUIREMENT OF THE NAVIGATION-PLANNED ROUTE

(75) Inventor: Yi-Kun Liu, Taoyuan County (TW)

Correspondence Address: KNOBBE MARTENS OLSON & BEAR LLP, 2040 MAIN STREET, FOURTEENTH FLOOR, IRVINE, CA, 92614, US

(73) Assignee: Mitac International Corporation, Taoyuan County (TW)

(21) Appl. No.: 12/398,879

(22) Filed: Mar. 5, 2009

(30) Foreign Application Priority Data
Mar. 5, 2008 (TW) 097107601

(51) Int. Cl. G01C 21/36

(52) U.S. Cl. 701/201

(57) ABSTRACT

A navigation device and a method for calculating estimated total time requirement of navigation-planned routes with enhanced prediction accuracy includes: a map database for pre-defining calculation parameter and properties of feasible road information and traffic signs along the routes; a configuration module for entering coordinates of indication points determined as a destination where a vehicle reaches; a route planning module for receiving satellite signals of global positioning system, searching the map database for the coordinate of the indication point determined as a departure place and defined by the satellite signals received by a satellite positioning system, and planning simulated routes between the indication point determined as the departure place and the indication point as the destination place; and a process module for calculating traveling time according to properties of the feasible road information of the planned simulated routes and total stopping time according to the calculation parameter and the number of traffic signs along the simulated routes, thus obtaining estimated total time requirement by adding up the traveling time and the total stopping time.

### BACKGROUND OF THE INVENTION

1. Field of the Invention

The present invention relates to an algorithm for estimating the time required by the navigation-planned route, and more particularly, to a navigation device and a method for calculating an estimated total time requirement of the navigation-planned route.

2. Description of Related Art

The Global Positioning System (GPS) is a U.S. space-based radionavigation system that provides reliable positioning, navigation, and timing services to civilian users on a continuous worldwide basis. GPS provides accurate location and time information for an unlimited number of people in all weather, day and night, anywhere in the world. The radionavigation system was initially launched for military use, tracking the locations of the mobile vehicles (e.g. airplane, warship, vessel, car and etc.) equipped with GPS receivers on a worldwide basis. Due to the ubiquity of privately owned vehicles (e.g. motorcycle and car), the radionavigation system is then gradually developed into a navigation device suitable for such vehicles. A GPS receiver calculates the vehicle's position by carefully timing the signals sent by the constellation of GPS satellites high above the Earth. Subsequently the coordinates of the vehicle's location are then compared to the drivable road information to the stored map database, thereby calculating the actual location of the road where the vehicle is currently on. In this way, the vehicle driver will be able to gain road information instantaneously.

In addition to the aforementioned positioning function, most of the current navigation devices have road navigation function, that is, the user sets a destination and the current location of the vehicle is then detected using the positioning function. Subsequently, the route optimization algorithm derives the navigation-planned route that leads to the destination within the shortest time. In accordance with the navigation-planned route and the positioning function, the routes traveled by the vehicle are recorded at every moment and the driver is instantaneously reminded of the distance away from the upcoming traffic light at the next intersection, as well as information like straight through or turning. In addition, the navigation device further has a function that calculates the time required for the vehicle to reach its destination so as to allow the user to better control the traveling schedule.

However, in order to calculate the time required reaching the destination using the aforementioned conventional navigation device, a destination must be pre-configured first, and after completion of the route planning, the aforementioned positioning function then detects the current location of the vehicle and calculates the remaining distance between the current location detected and the pre-configured destination. Subsequently, the remaining total distance is divided by the current traveling speed to instantaneously derive the approximate arrival time of the vehicle heading toward the destination. The aforementioned navigation device adopts a simpler method to calculate the approximate arrival time, but does take into consideration of different road conditions (e.g. speed limits of highways and city roads), traffic conditions (e.g. waiting time at the intersection) and other affecting factors, thereby causing the estimated required time reaching the destination being a lot less than the actual traveling time. Thus, it is usually difficult for the conventional system to provide a reliable traveling schedule.

Hence, it has become an urgent issue to designers in such a field to devise a navigation device to obtain a more reliable time data for reference and a method for calculating an estimated total time requirement based on the navigation-planned route.

### SUMMARY OF THE INVENTION

In view of the disadvantages of the aforementioned conventional technique, a primary objective of the present invention aims to provide a high accuracy navigation device and a method for calculating an estimated total time requirement based on the navigation-planned route, thereby reducing the difference between the estimated time and the actual traveling time.

Another objective of the present invention is to provide a navigation device that adopts a two-valued closed interval estimation and a method for calculating an estimated total time requirement based on the navigation-planned route, thereby increasing its reliability.

In order to achieve the aforementioned objectives and a further objective, the present invention provides a navigation device applicable to a vehicle. The navigation device includes: a satellite positioning system for receiving satellite signals indicating current location of the vehicle; a map database for storing a plurality of maps containing feasible road information, wherein each of the feasible road information has coordinates of a plurality of indication points and traffic signs, and pre-defines a calculation parameter and properties of the feasible road information and the traffic signs along the route; a configuration module for inputting the indication point determined as a destination where the vehicle reaches; a route planning module electrically connected to the satellite positioning system, the map database, and the configuration module and configured to search the map database for the coordinate of the indication point determined as a departure place and defined by the satellite signals received by the satellite positioning system and plan simulated routes between the indication point as the departure place and the indication point as the destination place using coordinates searched out from the map database according to the entered indication point as the destination place; and a process module electrically connected to the route planning module and configured to calculate a traveling time using each of the feasible road information and properties thereof obtained from the map database according to the simulated routes planned and calculate a total stopping time according to the calculation parameter of the obtained feasible road information and an actual number of traffic signs, leading to an estimated total time requirement which is a result of an addition of the traveling time and the total stopping time.

In correspondence to the aforementioned navigation device, the present invention discloses a method for calculating an estimated total time requirement of the navigation-planned route including the following steps: pre-defining a calculation parameter and properties of each of the feasible road information and the traffic signs along the route; entering the indication point determined as a destination where the vehicle reaches; searching the map database for the coordinate of the indication point determined as a departure place and defined by the satellite signals received by the satellite positioning system, and planning simulated routes between the indication point as the departure place and the indication point as the destination place using coordinates searched out from the map database according to the entered indication point determined as the destination place; and calculating the traveling time according to each of the feasible road information of the planned simulated routes, and calculating the total stopping time according to the calculation parameter of the obtained feasible road information and the actual number of traffic signs, leading to an estimated total time requirement which is a result of the addition of the traveling time and the total stopping time.

In a preferred embodiment of the present invention, the navigation device further includes a display module for displaying the result of the simulated routes planned and the estimated total time requirement.

In another preferred embodiment of the present invention, the feasible road information includes a speed limit and a period during which the speed limit applies. The speed limit is within a two-valued closed interval.

In a preferred embodiment of the present invention, the calculation parameter is the product of the probability encountering specific state of the traffic sign and the average waiting time. Specific state of the traffic sign includes a sign waiting time and a sign passing time, wherein the sign waiting time refers to either a state of straight-through halt or a state of turning halt.

However, the navigation device and the method for calculating an estimated total time requirement of the navigation-planned route according to the present invention primarily make use of the configuration module to enter coordinates of the indication point determined as a destination where the vehicle reaches. Subsequently, the route planning module then obtains the coordinate of the indication point determined as a departure place by receiving satellite signals of the Global Positioning System, so as to plan the simulated route between the indication point determined as the departure place and the indication point as the destination place, after which the traveling time is calculated according to properties of each of the feasible road information of the simulated route planned. In addition, the total stopping time is calculated according to the calculation parameter of the obtained feasible road information and the actual number of traffic signs. The traveling time and the total stopping time are added to obtain an estimated total time requirement, thereby reducing the difference between the estimated time and the actual traveling time and correspondingly raising the prediction accuracy.

### BRIEF DESCRIPTION OF THE DRAWINGS

FIG. 1 is a block diagram illustrating a structure of a navigation device according to the present invention;

FIG. 2A is a location diagram illustrating a route on which the vehicle installed with a navigation device of the present invention travels to the location S1;

FIG. 2B is a location diagram illustrating a route on which the vehicle installed with a navigation device of the present invention travels to the location S2; and

FIG. 3 is an application flowchart for illustrating a method for calculating an estimated total time requirement of the navigation-planned route according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

The following embodiments further illustrate the points of the present invention in detail, however the scope of the invention is not limited by any perceptions. The drawings in the present invention and their accompanying detailed description are directed to merely exemplary embodiments of the invention. The component count, shape and size are not drawn to scale in the drawings, thus during actual implementations, each component is allowed to be varied in accordance with the actual design.

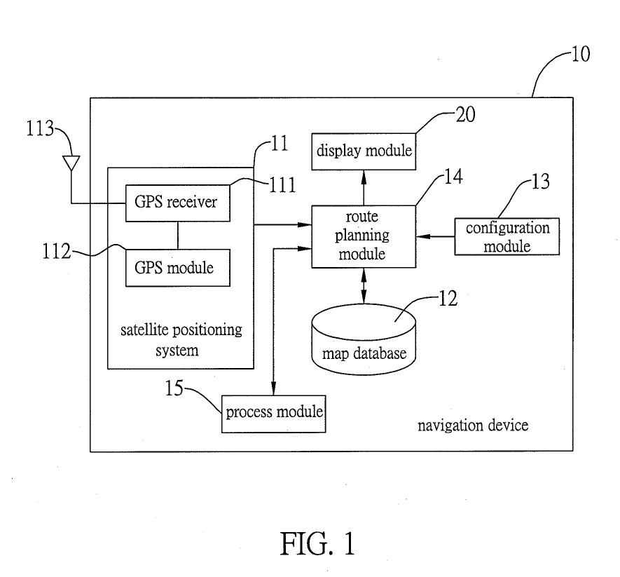

Referring to FIG. 1, a block diagram showing a structure of a navigation device according to the present invention is presented. As shown in the diagram, the navigation device 10 is installed on a vehicle (e.g. motor-bike, car or tourism bus). The navigation device 10 has functions of positioning and navigation route planning, and displays the simulated route plan and the estimated total time requirement so that the driver will be able to obtain the information of the relevant plan and the estimated total time requirement while driving the vehicle. The navigation device 10 includes a satellite positioning system 11, a map database 12, a configuration module 13, a route planning module 14, and a process module 15. The route planning module 14 is electrically connected to the satellite positioning system 11, the map database 12, the configuration module 13, and the process module 15.

The following explain each element of the navigation device as disclosed by the present invention in detail.

The satellite positioning system 11 is the Global Positioning System and may be used for receiving satellite signals indicating current location of the vehicle. In practice, the satellite positioning system 11 includes: a GPS receiver 111 and a GPS module 112 electrically connected to the GPS receiver 111, wherein the GPS receiver 111 receives the satellite positioning data issued by satellites via an antenna 113.

The map database 12 is used for storing a plurality of maps containing feasible road information, wherein each of the feasible road information comprises coordinates of a plurality of indication points and traffic signs, and pre-defines a calculation parameter and properties of the feasible road information and the traffic signs along the route. In particular, the indication points may be coordinates of specific landmarks or places of interest (e.g. school, hospital, gas station, place of interest or specific store), and properties of the feasible road information are speed limit and period during which the speed limit applies, wherein the speed limit is 50-60 km/h in cities and the speed limit on highways and expressways is allowed up to between 80-110 km/h. The period during which the speed limit applies is divided into peak and off-peak hours. It is to be noted that because of the same beginning, ending, driving route or even vehicles of the same performance, different drivers may have different driving speed. Hence, the speed limit for estimating the traveling time required to reach the destination lies in the two-valued closed interval. For example, the distance from the indication point determined as the departure place and detected at the current location to the indication point determined as the destination place is 30 kilometers. Assuming that the user travels at a speed of 50˜60 km/h, the traveling time is then between (30/60)˜(30/50) hour, which is equivalent to 30˜60 minutes, thereby relatively raising the accuracy in predicting the traveling time. Of course, the range of the two-valued interval must not be too big or else the estimation will then be meaningless and the data lose its value for reference.

The configuration module 13 is used for inputting the indication point determined as a destination where the vehicle reaches. In practice, the configuration module 13 has buttons or a keyboard for setting. In addition, the configuration module 13 combines with the display module 20 to form a mouse-controlled device or a touch-panel screen. For example, the mouse-controlled device is used to select, from the map displayed on the display module 20, the indication point determined as the destination place, or define the touch area corresponding to the configuration module 13 directly on the touch-panel screen for the user to directly select by touching. However, both the detailed hardware and software control techniques used on the input part of the aforementioned configuration module 13 to trigger the route planning module are not features of the present invention, thus they are not elaborated herewith.

The route planning module 14 electrically connected to the satellite positioning system 11, the map database 12, and the configuration module 13, is used for searching the map database 12 for the coordinate of the indication point determined as a departure place and defined by the satellite signals received by the satellite positioning system 11, and planning simulated routes between the indication point determined as the departure place and the indication point as the destination place using coordinates searched out from the map database according to the entered indication point determined as the destination place.

The process module 15 electrically connected to the route planning module 14 is used for calculating the traveling time using each of the feasible road information and properties thereof obtained from the map database according to the simulated routes planned, and calculating the total stopping time according to the calculation parameter of the obtained feasible road information and the actual number of traffic signs, leading to an estimated total time requirement which is a result of the addition of the traveling time and the total stopping time.

Based on the above, the calculation parameter in the map database 12 is the product of the probability encountering specific state of the traffic sign and the average waiting time, wherein the specific states of the traffic sign comprise a sign waiting time (e.g. red light) and a sign passing time (e.g. green light). More particularly, after the configuration module 13 configures the indication point determined as the destination place, the route planning module 14 plans a simulated route using coordinates searched out from the map database according to the entered indication point determined as the departure place, wherein the indication point determined as the departure place is obtained based on the satellite signals received at the current location of the vehicle. Subsequently, the process module 15, in addition to calculating the traveling time, also compiles a statistics of the number of traffic signs (n) along all the simulated routes planned, and pre-defines the probability (a) of encountering red light (based on general driving experiences, the probability of not encountering red light or encountering all lights is very low) and the average waiting time b on red. It is then approximated that the total stopping time on red is n×a×b sec. For example: there are 20 traffic signs on the way to the destination with 40% probability of encountering red light and the average waiting time is 40 seconds, thus the total stopping time is approximately 20×0.4×40=320 seconds. Later, the total stopping time and the traveling time are added by the process module 15 to obtain an estimated total time requirement which is then sent back to the route planning module 14. Finally the display module 20 displays the outcome.

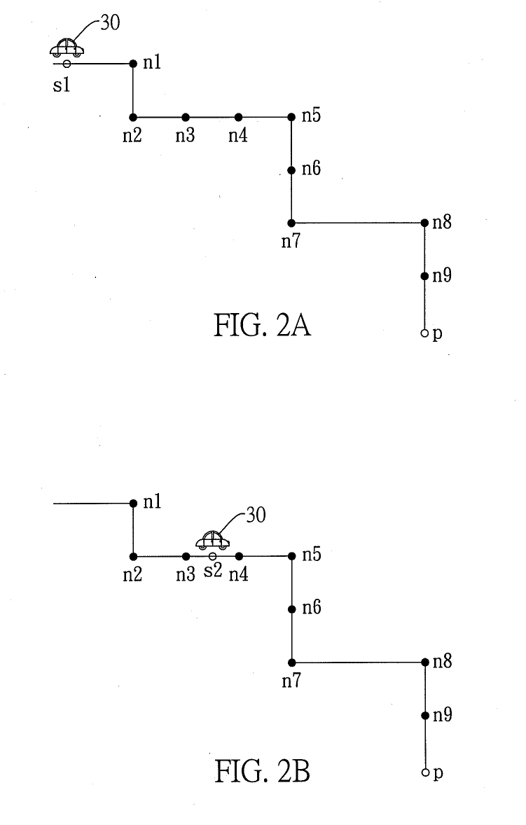

Referring to FIGS. 2A˜2B, a location relational diagram of the vehicle 30 installed with the navigation device of the present invention at different time of travel is shown. As shown in FIG. 2A, when the vehicle is driven to the indication point S1 determined as the departure place, the satellite positioning system 11 then detects the coordinates of the indication point S1. At this point, the process module 15 calculates the traveling time T1 required to reach the indication point P determined as the P destination place from the indication point S1, and the total stopping time (Tₙ₁₉) is derived according to the number of traffic signs (n1˜n9) and the product of the probability encountering specific state of the traffic sign and the average waiting time. Finally, an estimated total time requirement (T1+Tₙ₁₉) is then obtained after addition. As shown in FIG. 2B, after the vehicle continues to move toward the indication point P for a certain period, the satellite positioning system 11 will re-initiate detection of the indication point S2 determined as the departure place, thereby allowing the process module 15 to calculate the total stopping time (Tₙ₄₉) according to the remaining number of traffic signs (n4˜n9) after elimination of the traffic signs, n1 and n2, and the product of the probability encountering specific state of the traffic sign and the average waiting time, in addition to calculating the traveling time T2 required to reach the indication point P from the indication point S2. Finally, an estimated total time requirement (T1+Tₙ₁₉) is then obtained after addition. That is, the number of traffic signs used for total stopping time calculation shall theoretically decrease progressively as the vehicle gets closer to the indication point P, unless the route planning module is allowed to restructure the simulated routes, or else the total stopping time spent on the traffic sign will gradually decrease.

According to the above, in the present embodiment, the sign waiting time is of multi-states. For example, certain traffic sign only has straight-through halt state without turning halt state (i.e. right turn). Hence, when the vehicle 30 makes a turn while driving through the segment, it will be viewed as no traffic signs and the number of traffic signs will then be correspondingly reduced. For example, if the traffic signs n5 and n8 allow right turn on red (green arrow), they shall then be treated as straight-through on constant green. In order to calculate the number of traffic signs between the indication point S1 or S2 determined as a departure place and the indication point P determined as a destination place, the traffic signs n5 and n8 are then eliminated first, that is, if the vehicle 30 starts out from the indication point S1, the remaining number of traffic signs becomes 7 (n1, n2, n3, n4, n6, n7 and n9). On the other hand, as the vehicle 30 travels from the indication point S2, the number of traffic signs turns out to be 4 (n4, n6, n7, and n9).

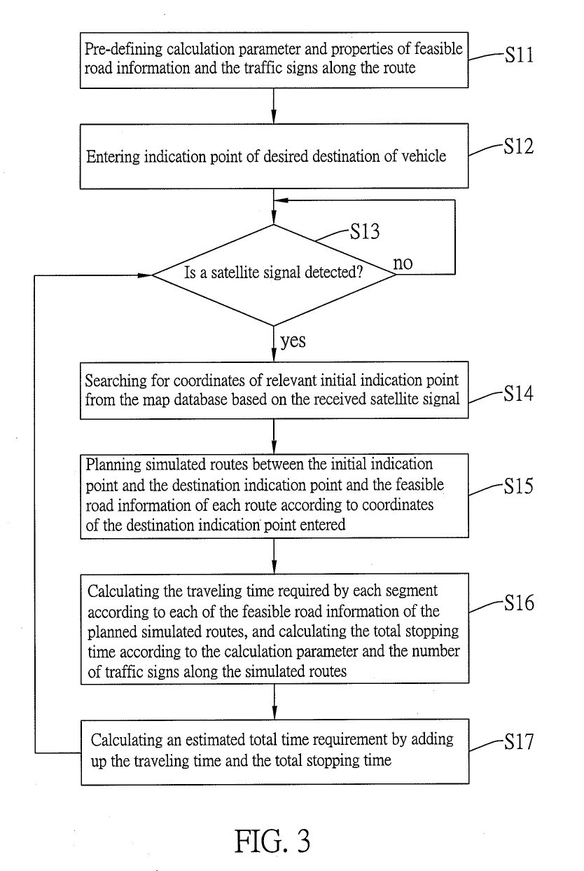

Referring to FIG. 3, an application flowchart of a method for calculating an estimated total time requirement of the navigation-planned route according to the present invention is illustrated. The method is applicable to a navigation device 10 installed on a vehicle, wherein the navigation device 10 comprises a satellite positioning system 11 for receiving satellite signals indicating locations of the vehicle, a map database 12 for storing a plurality of maps having feasible road information, and a route planning module 14 for planning simulated routes. Each of the feasible road information comprising coordinates of a plurality of indication points and traffic signs. Step S11 is carried out first.

At step S11, pre-defining calculation parameter and properties of feasible road information and traffic signs along the route, and going to S12.

At step S12, entering an indication point determined as a destination where a vehicle reaches, and going to S13.

At step S13, detecting, by satellite positioning system, a satellite signal indicating current location of vehicle, going to step S14 upon detection of the satellite signal, and repeating S13 otherwise.

At step S14, searching a map database for the coordinate of the indication point determined as a departure place and defined by the satellite signal received by the satellite positioning system, and going to S15.

At step S15, planning simulated routes between the indication point determined as the departure place and the indication point as the destination place using coordinates searched out from the map database according to the entered indication point determined as the destination place, and going to S16.

At step S16, calculating the traveling time using each of the feasible road information and properties thereof obtained from the map database according to the simulated routes planned, calculating total stopping time according to the calculation parameter of the obtained feasible road information and an actual number of traffic signs, and going to S17.

At step S17, calculating estimated total time requirement by adding up traveling time and the total stopping time, and going back to step S13 for re-detection.

In summary, the present invention provides a navigation device and a method for calculating an estimated total time requirement of the navigation-planned route, primarily using the configuration module to enter the coordinates of the indication point determined as a destination where the vehicle reaches. Subsequently, the route planning module receives satellite signals of the Global Positioning System to obtain the coordinate of the indication point determined as a departure place, thereby planning the simulated routes between the indication point determined as the departure place and the indication point as the destination place. Subsequently, the traveling time is calculated using each of the feasible road information and properties thereof obtained from the map database according to the simulated routes planned, and the total stopping time is calculated according to the calculation parameter of the obtained feasible road information and the actual number of traffic signs. An estimated total time requirement is therefore a result of the addition of the traveling time and the total stopping time, thereby reducing the difference between the estimated time and the actual traveling time and relatively raising the prediction accuracy.

While the invention has been particularly shown and described with reference to preferred embodiments for purposes of illustration, it will be understood that variations and modifications can be effected thereto by those skilled in the art without departing from the spirit and scope of the invention as defined by the appended claims.

What is claimed is:

1. A navigation device applicable to a vehicle, comprising:
a satellite positioning system for receiving satellite signals indicating current location of the vehicle;
a map database for storing a plurality of maps containing feasible road information, wherein each of the feasible road information has coordinates of a plurality of indication points and traffic signs, and a calculation parameter and properties of the feasible road information and the traffic signs along a route are pre-defined;
a configuration module for inputting the indication point determined as a destination where the vehicle reaches;
a route planning module electrically connected to the satellite positioning system, the map database, and the configuration module and configured to search the map database for the coordinate of the indication point determined as a departure place and defined by the satellite signals received by the satellite positioning system and plan simulated routes between the indication point as the departure place and the indication point as the destination place using coordinates searched out from the map database according to the entered indication point determined as the destination place; and
a process module electrically connected to the route planning module and configured to calculate a traveling time using each of the feasible road information and properties thereof obtained from the map database according to the simulated routes planned and calculate a total stopping time according to the calculation parameter of the obtained feasible road information and an actual number of traffic signs, leading to an estimated total time requirement which is a result of an addition of the traveling time and the total stopping time.

2. The navigation device of claim 1, wherein the navigation device further comprises a display module for displaying the simulated route plan and the estimated total time requirement.

3. The navigation device of claim 1, wherein the properties of the feasible road information comprise a speed limit and a period during which the speed limit applies.

4. The navigation device of claim 3, wherein the speed limit is within a two-valued closed interval.

5. The navigation device of claim 1, wherein the calculation parameter is the product of the probability encountering specific state of the traffic sign and the average waiting time.

6. The navigation device of claim 5, wherein specific state of the traffic sign comprises a sign waiting time and a sign passing time.

7. The navigation device of claim 6, wherein the sign waiting time refers to a state of straight-through halt.

8. The navigation device of claim 6, wherein the sign waiting time refers to a state of turning halt.

9. A method for calculating an estimated total time requirement of the navigation-planned route, the method being configured for use with a navigation device applicable to a vehicle, wherein the navigation device comprises a satellite positioning system for receiving satellite signals indicating locations of the vehicle, a map database for storing a plurality of maps having feasible road information, and a route planning module for planning simulated routes, each of the feasible road information comprising coordinates of a plurality of indication points and traffic signs, wherein the method for calculating an estimated total time requirement of the route planned by the route planning module comprises the following steps:
pre-defining a calculation parameter and properties of each of the feasible road information and the traffic signs along the route;
entering the indication point determined as a destination where the vehicle reaches;
searching a map database for the coordinate of the indication point determined as a departure place and defined by the satellite signals received by the satellite positioning system, and planning simulated routes between the indication point as the departure place and the indication point as the destination place using the coordinates searched out from the map database according to the entered indication point determined as the destination place; and
calculating a traveling time using each of the feasible road information and properties thereof obtained from the map database according to the simulated routes planned, and calculating a total stopping time according to the calculation parameter of the obtained feasible road information and an actual number of traffic signs, leading to an estimated total time requirement which is a result of an addition of the traveling time and the total stopping time.

10. The method of claim 9, wherein a display module displays the result of the simulated routes planned and the estimated total time requirement.

11. The method of claim 9, wherein properties of the feasible road information comprise a speed limit and a period during which the speed limit applies.

12. The method of claim 11, wherein the speed limit is within a two-valued closed interval.

13. The method of claim 9, wherein the calculation parameter is the product of the probability encountering halt and the average waiting time.

14. The navigation device of claim 13, wherein specific state of the traffic sign comprises a sign waiting time and a sign passing time.

15. The navigation device of claim 14, wherein the sign waiting time refers to a state of straight-through halt.

16. The navigation device of claim 14, wherein the sign waiting time refers to a state of turning halt.
